(19) United States
(12) Patent Application Publication
(10) Pub. No.: US 2020/0227021 A1
(43) Pub. Date: Jul. 16, 2020

(54) CONSUMER APPLIANCES HAVING ONE OR MORE NOISE CANCELLATION FEATURES

(71) Applicant: Haier US Appliance Solutions, Inc., Wilmington, DE (US)

(72) Inventor: Michael Goodman Schroeder, Louisville, KY (US)

(21) Appl. No.: 16/245,551

(22) Filed: Jan. 11, 2019

(51) Int. Cl. G10K 11/178

(52) U.S. Cl. CPC G10K 11/178; G10K 2210/121; G10K 2210/109; G10K 2210/1054

(57) ABSTRACT

A consumer appliance is provided herein. The consumer appliance may include a cabinet, an exterior panel, an electromechanical driver, an electromechanical receiver, and a controller. The cabinet may define an internal chamber. The exterior panel may be mounted to the cabinet. The electromechanical driver may be fixed to the exterior panel to generate a soundwave therefrom. The electromechanical receiver may be mounted within the cabinet. The controller may be configured to initiate a noise canceling operation. The noise canceling operation may include receiving a noise input signal at the electromechanical receiver and initiating an anti-noise wave at the electromechanical driver through the exterior panel based on the received noise input signal.

### FIELD OF THE INVENTION

The present subject matter relates generally to consumer appliances, and more particularly to consumer appliances having one or more features for masking or canceling noise within the surrounding or ambient environment.

### BACKGROUND OF THE INVENTION

The amount of noise generated by consumer appliances (e.g., refrigerator appliances, oven or cooking appliances, dishwashing appliances, washing machine appliances, dryer appliances, range hoods, etc.) has generally decreased over time. Advances in technology allow modern consumer appliances to generate less noise than most consumer appliances did several years ago. Advanced damping materials have also reduced the amount of audible noise that modern consumer appliances emit. However, excessive or undesirable noise within a room that houses a consumer appliance remains a constant concern for users. In some instances, undesirable noise is generated by a specific consumer appliance. In other instances, undesirable noise is the collective or ambient sounds generated by multiple sources and a given environment. In either case, undesirable noise or noise levels will often disturb users and reduce their overall enjoyment of a given appliance.

Attempts have been made to mask or cancel out noise by using sound (e.g., anti-noise signals) in a phase opposite of the phase of the noise. Generally, sound sources, such as speakers, are required to transmit such sounds. Often, the sound sources require especially large components or diaphragms in order to generate sound of the appropriate frequency. For instance, large consumer appliances can produce relatively low frequencies, thereby requiring relatively large diaphragms. Such components naturally either increase the overall size of a consumer appliance, reduce the amount of available usable space for the consumer appliance, or both. Moreover, these components may increase material costs and complexity for assembly. Furthermore, it is often difficult to know or determine the correct frequency or frequencies at which a noise canceling sound should be projected.

Therefore, it would be useful provide a consumer appliance configured to address one or more of the above identified issues. In particular, it may be advantageous to provide a consumer appliance having features determining or generating a noise cancellation signal without significantly affecting the size or usable space of a consumer appliance.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a consumer appliance is provided. The consumer appliance may include a cabinet, an exterior panel, an electromechanical driver, an electromechanical receiver, and a controller. The cabinet may define an internal chamber. The exterior panel may be mounted to the cabinet. The electromechanical driver may be fixed to the exterior panel to generate a soundwave therefrom. The electromechanical receiver may be mounted within the cabinet. The controller may be configured to initiate a noise canceling operation. The noise canceling operation may include receiving a noise input signal at the electromechanical receiver and initiating an anti-noise wave at the electromechanical driver through the exterior panel based on the received noise input signal.

In another exemplary aspect of the present disclosure, a consumer appliance is provided. The consumer appliance may include a cabinet, a first panel, a second panel, an electromechanical driver, an electromechanical receiver, and a controller. The cabinet may define an internal chamber and a mechanical compartment spaced apart from the internal chamber. The first panel may be mounted to the cabinet. The first panel may be an exterior panel. The second panel may be mounted to the cabinet and spaced apart from the first panel. The electromechanical driver may be fixed to the first panel to generate a soundwave therefrom. The electromechanical receiver may be mounted within the mechanical compartment. The controller may be configured to initiate a noise canceling operation. The noise canceling operation may include receiving a noise input signal at the electromechanical receiver and initiating an anti-noise wave at the electromechanical driver through the first panel based on the received noise input signal.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a consumer appliance, specifically a refrigerator appliance, according to exemplary embodiments of the present disclosure.

FIG. 2 provides a schematic side view of a consumer appliance according to exemplary embodiments of the present disclosure.

FIG. 3 provides a perspective view of a portion of a mechanical compartment of a consumer appliance according to exemplary embodiments of the present disclosure.

FIG. 4 provides a schematic side view of a consumer appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

Generally, some aspects of the present disclosure provide a consumer appliance (e.g., refrigerator appliance) that has an electromechanical receiver and electromechanical driver. One or both of the electromechanical receiver or driver may be mounted within a cabinet of the consumer appliance. During use, noise may be detected at the electromechanical receiver, and the electromechanical driver may generate an anti-noise wave to mask or cancel out the detected noise.

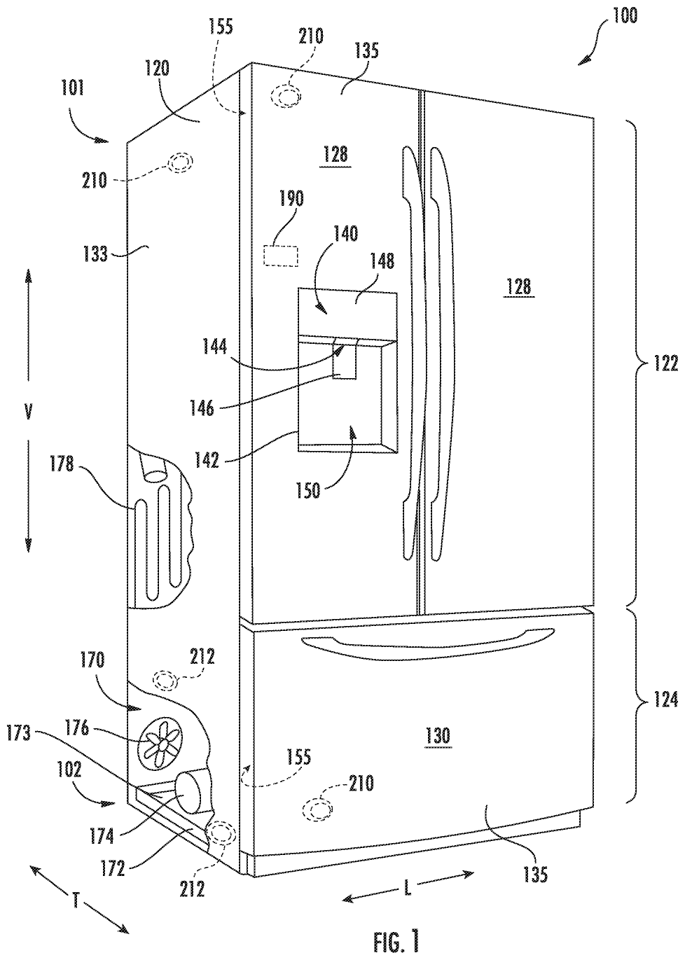

Turning now to the figures, FIG. 1 provides a front, perspective view of a consumer appliance 100 according to exemplary embodiments of the present disclosure (e.g., as a cooking appliance). Appliance 100 includes a cabinet or housing 120 that extends between a top portion 101 and a bottom portion 102 along a vertical direction V. A lateral direction L and a transverse direction T are also defined by the cabinet 120 to define a mutually-orthogonal direction system with the vertical direction V. As shown, cabinet 120 includes or is formed by one or more exterior panels (e.g., body panels 133) mounted. When assembled, the body panels 133 define an interior of the cabinet 120. Within the interior, cabinet 120 defines one or more internal chambers. For example, as shown in the exemplary appliance 100 of FIG. 1, cabinet 120 may define one or more chilled chambers for receipt of food items for storage. In certain embodiments, housing 120 defines fresh food chamber 122 positioned at or adjacent to top portion 101 of housing 120 and a freezer chamber 124 arranged at or adjacent to bottom portion 102 of housing 120. As such, refrigerator appliance 100 is generally referred to as a bottom mount refrigerator. However, as will be understood by those skilled in the art, appliance 100 is provided by way of example only, and the present subject matter may be used in any suitable consumer appliance (e.g., oven appliance, dishwashing appliance, washing machine appliance, dryer appliance, range hood, etc.). Thus, the exemplary embodiments illustrated in the figures are not intended to limit the present subject matter to any particular appliance, configuration, or arrangement, except as otherwise indicated.

In some embodiments, one or more doors are attached to housing 120. In the exemplary embodiments of FIG. 1, refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 may be coupled to a freezer drawer (not shown) slidably mounted within freezer chamber 124. Refrigerator doors 128 and freezer door 130 are shown in a closed configuration in FIG. 1. As is understood, each of the doors 128, 130 may be formed by one or more exterior panels (e.g., door panels 135 extending along a front portion of the corresponding door 128 or 130) that are separated from or spaced apart from the body panels 133 (e.g., along the transverse direction T).

In some embodiments, appliance 100 includes a dispensing assembly 140 for dispensing liquid water or ice. Dispensing assembly 140 includes a dispenser 142 positioned on or mounted to an exterior portion of refrigerator appliance 100 (e.g., on one of doors 128). Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle. A user interface panel 148 is provided for controlling the mode of operation. For example, user interface panel 148 includes a plurality of user inputs (not labeled), such as a water dispensing button and an ice-dispensing button, for selecting a desired mode of operation such as crushed or non-crushed ice.

Generally, discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open doors 128. In the exemplary embodiment, dispenser recess 150 is positioned at a level that approximates the chest level of a user.

In some embodiments, a mechanical compartment 170 is defined by housing 120 (e.g., at bottom portion 102 of housing 120, spaced apart from chamber 122 or 124). Optionally, a drain pan 172 may be positioned within mechanical compartment 170. In some such embodiments, drain pain 172 is formed from one or more planar, metal pan panels 173. Liquid or water from one or more portions of the refrigerator appliance 100 may collect within the drain pan 172. Additionally or alternatively, one or more portions of a sealed cooling system may be provided on or near drain pan 172. When assembled, a compressor 174 or condenser (not pictured) of the sealed system can be positioned, for example, on or adjacent to drain pan 172. In some such embodiments, heat from condenser can assist with evaporation of liquid water in drain pan 172. A fan 176 may be configured for cooling compressor 174 or condenser, and can also direct a flow air across or into drain pan 172. Thus, fan 176 can be positioned on or adjacent to drain pan 172. Additionally or alternatively, an evaporator 178 in fluid communication with compressor 174 may be mounted on or within cabinet 120 above the drain pan 172. Drain pan 172 may be sized and shaped for facilitating evaporation of liquid water therein. For example, drain pan 172 may be open-topped and extend across about a width or a depth of housing 120.

In certain embodiments, one or more electromechanical drivers 210 are fixed to one or more of the panels (e.g., body panels 133, door panels 135, or pan panels 173). Generally, an electromechanical driver 210 is configured for converting one or more electrical signals (e.g., digital sound signals) to vibrations. For instance, electromechanical driver 210 may include a voice coil held coaxial to a permanent magnet and suspension, similar to that found within a dynamic loudspeaker. When fixed to a corresponding panel (e.g., 133, 135, 173), electromechanical driver 210 may vibrate with at least a portion of the panel. Thus, the corresponding panel may act as a diaphragm for projecting soundwaves 220 corresponding to the electrical signal received at the electromechanical driver 210.

In additional or alternative embodiments, one or more electromechanical receivers 212 are mounted within the cabinet 120. Generally, electromechanical receiver 212 is configured for converting one or more received soundwaves 222 or vibrations to one or more electrical signals (e.g., noise input signal). In some embodiments, an electromechanical receiver 212 is included as part of a self-contained microphone assembly (e.g., dynamic microphone, ribbon microphone, fiber-optic microphone, piezoelectric microphone, etc.). In additional or alternative embodiments, an electromechanical receiver 212 is fixed to one or more to one or more of the panels (e.g., body panels 133, door panels 135, or pan panels 173). As an example, electromechanical receiver 212 may include an accelerometer or piezoelectric element fixed on internal surface of the corresponding panel (e.g., 133, 135, 173). As another example, electromechanical receiver 212 may include an induction coil positioned coaxial to a permanent magnet, similar to that found within a dynamic microphone. When fixed to a corresponding panel, electromechanical receiver 212 may vibrate with at least a portion of the corresponding panel. Thus, the corresponding panel may act as a diaphragm for receiving soundwaves 222 which may then be detected as one or more corresponding electrical signals at the electromechanical receiver 212.

Operation of the refrigerator appliance 100, including electromechanical driver 210 or electromechanical receiver 212, can be regulated by a controller 190 that is operatively coupled to user interface panel 148 or various other components. User interface panel 148 provides selections for user manipulation of the operation of refrigerator appliance 100 such as, for example, one or more noise canceling operations. In response to user manipulation of user interface panel 148 or one or more sensor signals, controller 190 may operate various components of the refrigerator appliance 100. Controller 190 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 190 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 190 may be positioned in a variety of locations throughout refrigerator appliance 100. In the illustrated embodiment, controller 190 is located adjacent to user interface panel 148 within refrigerator door 128. In other embodiments, the controller 190 may be positioned at any suitable location within refrigerator appliance 100, such as for example within a fresh food chamber 122, a freezer door 130, etc. Input/output (“I/O”) signals may be routed between controller 190 and various operational components of refrigerator appliance 100. For example, user interface panel 148, electromechanical driver 210, or electromechanical receiver 212 may be in communication with controller 190 via one or more signal lines or shared communication busses.

As illustrated, controller 190 may be in communication with the various components of dispensing assembly 140 and may control operation of the various components. For example, the various valves, switches, etc. may be actuatable based on commands from the controller 190. As discussed, electromechanical driver 210 or electromechanical receiver 212 may additionally be in communication with the controller 190. Thus, the various operations may occur based on user input or automatically through controller 190 instruction. In some such embodiments, controller 190 is configured to initiate a noise canceling operation that generally provides for canceling one or more detected noises. For instance, the noise canceling operation may include receiving a noise input signal at the electromechanical receiver 212 and initiating an anti-noise wave 220 at the electromechanical driver 210.

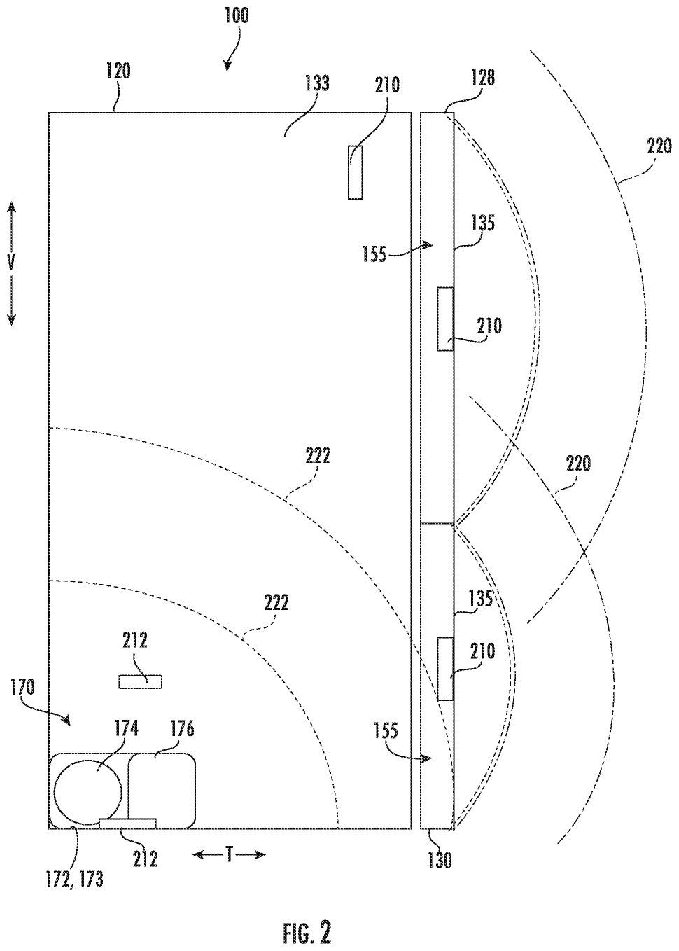

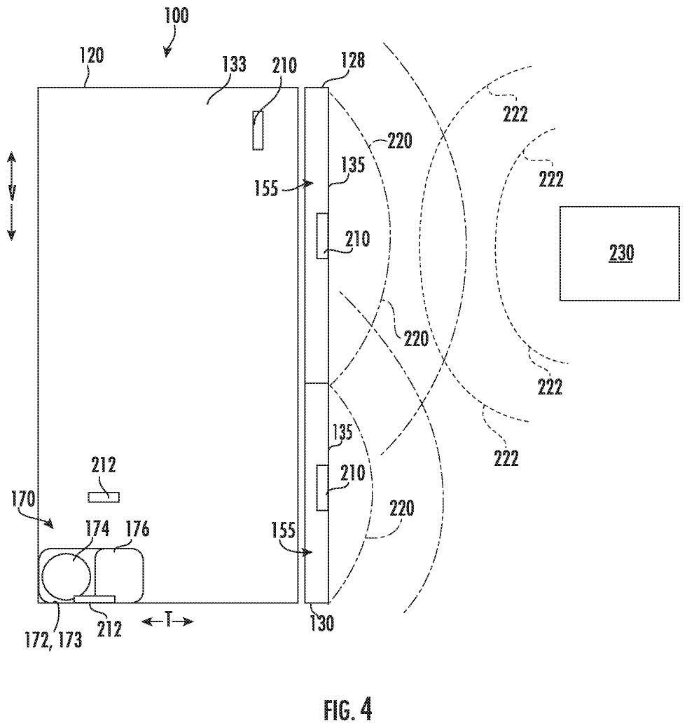

In some embodiments, the noise input signal may correspond to a soundwave 222 emitted from an internal component of the appliance 100 (as illustrated at FIG. 2). In other words, the detected soundwave 222 may be generated within the interior of the cabinet 120 (e.g., from a compressor 174, fan 176, etc.). Thus, the noise input signal may be an internal vibration noise signal corresponding to a soundwave 222 within an interior of the cabinet 120. In additional or alternative embodiments, the noise input signal may correspond to a soundwave 222 emitted from an external sound source 230 (as illustrated at FIG. 4). The external sound source 230 may be another discrete appliance, one or more users in close proximity to the appliance 100, or the general ambient environment surrounding the appliance 100. Thus, the noise input signal may correspond to a soundwave 222 transmitted from the exterior of the cabinet 120 to the interior of the cabinet 120.

As shown, for instance at FIGS. 2 and 4, the initiated anti-noise wave 220 may be emitted or propagated emitted from vibrations induced at one or more of the panels (e.g., 133, 135, 173), which correspond to movement caused by electromechanical receiver 212. Generally, the anti-noise wave 220 may be of the same amplitude as the soundwave 222 corresponding to the noise input signal, but of an inverted phase. Thus, the anti-noise wave 220 may cause destructive interference of the original soundwave 222, as is understood.

As illustrated in FIGS. 1, 2, and 4, one or more suitable locations may be provided for an electromechanical driver 210 within appliance 100. As an example, an electromechanical driver 210 may be fixed to a front door panel 135 of a refrigerator door 128 or freezer door 130. In such embodiments, the electromechanical driver 210 may generally be contained within an internal door cavity 155 defined by the corresponding refrigerator door 128 or freezer door 130 (e.g., forward from an internal chamber, such as fresh food chamber 122 or freezer chamber 124, defined by cabinet 120) and generally hidden from view. Moreover, the corresponding door panel 135 may serve to act as a diaphragm from which sound (e.g., 220) is projected. As another example, an electromechanical driver 210 may be fixed to an interior surface of a side body panel 133 of the cabinet 120. Thus, the electromechanical driver 210 may be contained within an insulated region of the cabinet 120 that is between the body panel 133 and the internal chambers 122, 124, while the body panel 133 may serve to act as a diaphragm which sound (e.g., 220) is projected. As an additional or alternative example, in electromechanical driver 210 may be fixed to a portion of the drain pan 172 (e.g., within a mechanical compartment 170 defined by cabinet 120). Thus, panel 173 of the drain pan 172 may serve to act as a diaphragm from which sound is projected.

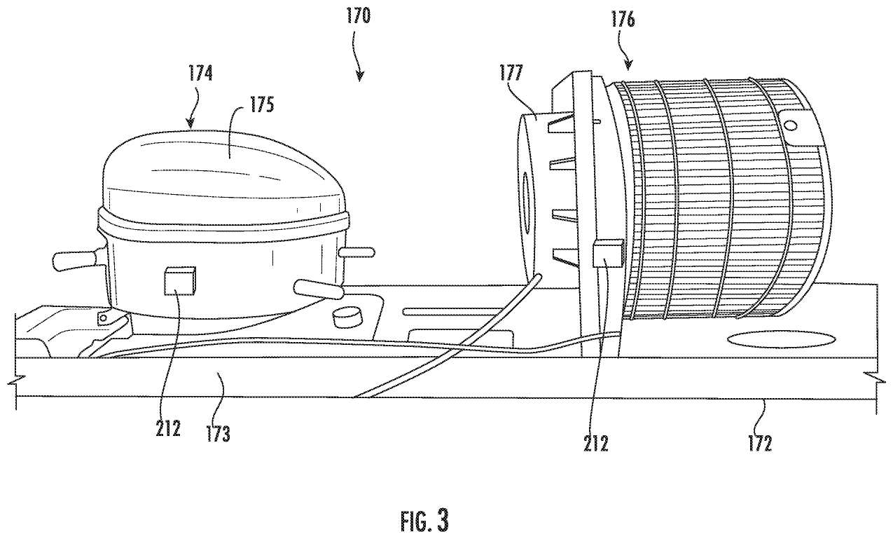

As illustrated in FIGS. 1 through 4, one or more suitable locations may also be provided for an electromechanical receiver 212 within appliance 100. As an example, an electromechanical driver 210 may be fixed to an interior surface of a side body panel 133 of the cabinet 120. Thus, the electromechanical receiver 212 may be contained within an insulated region of the cabinet 120 that is between the body panel 133 and the internal chambers 122, 124, while the body panel 133 may serve to act as a diaphragm at which sound (e.g., 222) is received. As an additional or alternative example, in electromechanical driver 210 may be fixed to a portion of the drain pan 172 (e.g., within a mechanical compartment 170 defined by cabinet 120). Thus, panel 173 of the drain pan 172 may serve to act as a diaphragm at which sound (e.g., 222) is received. As another additional or alternative example, especially illustrated at FIG. 3, one or more electromechanical drivers 210 may be fixed directly on an active component within the cabinet 120 (e.g., within mechanical compartment 170). For instance, an electromechanical driver 210 may be fixed directly to a casing 175 of the compressor 174 or a casing₁₇₇ of the fan 176. Thus, soundwaves 222 generated at such active components may be detected (e.g., directly as a soundwave or indirectly as a vibration) without interference or damping from intermediate components.

Advantageously, the described exemplary embodiments may significantly reduce the perceptible volume of undesirable noise soundwave 222 in, or surrounding, the appliance 100. For instance, relatively large size and described proximity of the panels 133, 135, 173 to the original soundwave 222 may permit an advantageous and efficient canceling of noise from or surrounding the appliance 100. Moreover, the appliance 100 may readily respond to and adapt to changes in amplitude or volume of undesirable noise within or adjacent to the appliance 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A consumer appliance comprising:
a cabinet defining an internal chamber;
an exterior panel mounted to the cabinet;
an electromechanical driver fixed to the exterior panel to generate a soundwave therefrom;
an electromechanical receiver mounted within the cabinet; and
a controller configured to initiate a noise canceling operation, the noise canceling operation comprising
receiving a noise input signal at the electromechanical receiver, and
initiating an anti-noise wave at the electromechanical driver through the exterior panel based on the received noise input signal.

2. The consumer appliance of claim 1, wherein the exterior panel is a first panel, wherein the consumer appliance further comprises a second panel spaced apart from the first panel, and wherein the electromechanical receiver is fixed to the second panel.

3. The consumer appliance of claim 1, further comprising a drain pan mounted within the cabinet, wherein the electromechanical receiver is fixed to the drain pan.

4. The consumer appliance of claim 1, further comprising a fan comprising a casing mounted within the cabinet, wherein the electromechanical receiver is fixed to the casing.

5. The consumer appliance of claim 1, further comprising a compressor comprising a casing mounted within the cabinet, wherein the electromechanical receiver is fixed to the casing.

6. The consumer appliance of claim 1, wherein the noise input signal is an ambient noise signal corresponding to a soundwave transmitted from an exterior of the cabinet to an interior of the cabinet.

7. The consumer appliance of claim 1, wherein the noise input signal is an internal vibration noise signal corresponding to a soundwave within an interior of the cabinet.

8. The consumer appliance of claim 1, wherein the exterior panel is a first panel, wherein the electromechanical driver is a first electromechanical driver, wherein the consumer appliance further comprises:
a second panel spaced apart from the first panel; and
a second electromechanical driver fixed to the second panel.

9. The consumer appliance of claim 1, wherein the exterior panel is a first panel, wherein the electromechanical receiver is a first electromechanical receiver, wherein the consumer appliance further comprises:
a second panel spaced apart from the first panel; and
a second electromechanical receiver fixed to the second panel.

10. The consumer appliance of claim 1, wherein the consumer appliance is a refrigerator appliance.

11. The consumer appliance of claim 1, further comprising a door rotatably mounted to the cabinet, wherein the door comprises an exterior door panel, and wherein the exterior panel is the exterior door panel.

12. A consumer appliance comprising:
a cabinet defining an internal chamber and a mechanical compartment spaced apart from the internal chamber;
a first panel mounted to the cabinet, the first panel being an exterior panel;
a second panel mounted to the cabinet and spaced apart from the first panel;
an electromechanical driver fixed to the first panel to generate a soundwave therefrom;
an electromechanical receiver mounted within the mechanical compartment; and
a controller configured to initiate a noise canceling operation, the noise canceling operation comprising
receiving a noise input signal at the electromechanical receiver, and
initiating an anti-noise wave at the electromechanical driver through the first panel based on the received noise input signal.

13. The consumer appliance of claim 12, further comprising a drain pan mounted within the mechanical compartment, wherein the electromechanical receiver is fixed to the drain pan.

14. The consumer appliance of claim 12, further comprising a fan comprising a casing mounted within the mechanical compartment, wherein the electromechanical receiver is fixed to the casing.

15. The consumer appliance of claim 12, further comprising a compressor comprising a casing mounted within the mechanical compartment, wherein the electromechanical receiver is fixed to the casing.

16. The consumer appliance of claim 12, wherein the noise input signal is an ambient noise signal corresponding to a soundwave transmitted from an exterior of the cabinet to an interior of the cabinet.

17. The consumer appliance of claim 12, wherein the noise input signal is an internal vibration noise signal corresponding to a soundwave within an interior of the cabinet.

18. The consumer appliance of claim 12, wherein the electromechanical driver is a first electromechanical driver, wherein the second panel is an exterior panel, and wherein the consumer appliance further comprises a second electromechanical driver fixed to the second panel.

19. The consumer appliance of claim 12, wherein the consumer appliance is a refrigerator appliance.

20. The consumer appliance of claim 12, further comprising a door rotatably mounted to the cabinet, wherein the door comprises an exterior door panel, and wherein the exterior panel is the exterior door panel.
